(19) United States
(12) Patent Application Publication
(10) Pub. No.: US 2015/0023794 A1
(43) Pub. Date: Jan. 22, 2015

(54) ROTOR HUB OF A WIND TURBINE GENERATOR SYSTEM

(71) Applicant: SIEMENS AKTIENGESELLSCHAFT, MUNCHEN (DE)

(72) Inventors: HENNING EBBESEN, SKJERN (DK); THORKIL MUNK-HANSEN, GIVE (DK)

(21) Appl. No.: 14/301,379

(22) Filed: Jun. 11, 2014

(30) Foreign Application Priority Data
Jul. 18, 2013 (DE) 102013214133.5

(51) Int. Cl. F03D 11/00

(52) U.S. Cl. CPC F03D 11/0075
USPC 416/204 R

(57) ABSTRACT

A rotor hub of a wind turbine generator system is provided. A rotor hub of a wind turbine generator system comprises at least two connecting points for respectively receiving a rotor blade. The rotor hub is surrounded by a cladding, the cladding having at least two clearances respectively for a rotor blade. Between the two connecting points for receiving the rotor blades, the spacing between the rotor hub cladding and the rotor hub is set so as to create between the rotor hub cladding and the rotor hub a hollow space that is large enough to allow servicing work on the connecting point between the rotor blade and the rotor hub to be carried out by a worker from there.

### CROSS-REFERENCE TO RELATED APPLICATIONS

This application claims priority to DE Application No. 102013214133.5, having a filing date of Jul. 18, 2013, the entire contents of which are hereby incorporated by reference.

### FIELD OF TECHNOLOGY

The following relates to a rotor hub of a wind turbine generator system.

### BACKGROUND

A wind turbine generator system often comprises at least two rotor blades, which are typically fastened to a rotor hub. The rotor hub ordinarily is rotatably attached to the nacelle of the wind turbine generator system. The nacelle of the wind turbine generator system may be rotatably arranged on a tower.

A rotor blade may be connected to the rotor hub by way of a bearing, so that it is rotatable about its longitudinal axis. The rotor hub may have at least two receptacles for rotor blades.

The rotor hub of a wind turbine generator system is usually produced as a casting. It often has a connecting point for fastening to the nacelle of the wind turbine generator system.

The rotor hub is commonly provided with a cladding. This serves for protecting the rotor hub and various units that are fastened to the rotor hub from effects of weathering. In addition, the rotor hub cladding serves for visual purposes; it conceals the rotor hub and any units that may be present.

In the course of servicing a wind turbine generator system, work is also often carried out on the fastening and bearings of the rotor blades. This may involve an inspection, the tightening of bolts and/or the exchange of a seal.

Some of this work is carried out from outside the rotor hub. For this purpose, it is necessary for a worker to leave the nacelle of the wind turbine generator system and carry out the servicing work on the outside of the installed rotor hub. Work of this kind entails a high safety risk for the worker.

### SUMMARY

An aspect relates to an assembly comprising a rotor hub and a rotor hub cladding that minimizes the safety risk for the worker.

A further aspect relates to the combination of features in the independent claim. Various embodiments are described in the subclaims.

A rotor hub of a wind turbine generator system may comprise at least two connecting points for respectively receiving a rotor blade. The rotor hub may be surrounded by a cladding, the cladding having at least two clearances respectively for a rotor blade. Between the two connecting points for receiving the rotor blades, the spacing between the rotor hub cladding and the rotor hub may be set so as to create between the rotor hub cladding and the rotor hub a hollow space that is large enough to allow servicing work on the connecting point between the rotor blade and the rotor hub to be carried out by a worker from there.

A wind turbine generator system includes at least two rotor blades. These rotor blades may be attached to the rotor hub. For this purpose, connecting points for receiving a rotor blade may be provided on the rotor hub. The rotor hub may be surrounded by a rotor hub cladding. This rotor hub cladding may have at least two clearances, through which the rotor blades may be mounted on the rotor hub.

For the connection of the rotor blades to the rotor hub, a fastening by means of fastening means is provided. A rotor blade may be connected to the hub by way of a bearing.

Servicing work periodically may need to be carried out both on the fastening means and on the bearing. For this purpose, the connecting point between the rotor blade and the rotor hub can be accessible for servicing work.

Between two connecting points for receiving the rotor blades, the spacing between the rotor hub cladding and the rotor hub may be set so as to create a hollow space between the rotor hub and the rotor hub cladding. This hollow space may be created such that it is large enough to allow servicing work on the connecting point between the rotor blade and the rotor hub to be carried out by a worker from this hollow space.

As a result, the servicing work can be carried out from the hollow space between the rotor hub cladding and the rotor hub. This can enable the worker who is carrying out the servicing work to carry it out from inside the rotor hub cladding.

As a result, it may be no longer necessary that the worker has to leave the rotor hub cladding and carry out the servicing work on the connecting point of the rotor blades from outside the rotor hub. This makes the servicing work more independent of effects caused by weathering. Furthermore, the safety risk to the worker carrying out the servicing work may be reduced significantly.

The rotor blades may be attached to the rotor hub by means of fastening means. The fastening means may be accessible from the hollow space between the rotor hub and the rotor hub cladding.

This may allow servicing work to be carried out on the fastening means from the hollow space between the rotor hub and the rotor hub cladding. It is consequently not necessary for the worker carrying out the servicing work to leave the rotor hub and carry out the servicing work from outside the rotor hub cladding.

Bolts may be provided as fastening means for fastening the rotor blades to the rotor hub and have to be inspected or tightened in the course of regular servicing work.

The rotor blades may be connected to the rotor hub by way of bearings. The bearings may be accessible from the hollow space between the rotor hub and the rotor hub cladding.

This may allow servicing work that has to be carried out on the bearings to be carried out from the hollow space between the rotor hub and the rotor cladding.

Ball bearings or rolling bearings may be used as bearings for mounting the rotor blades. The servicing work on these bearings may be inspection of the bearings, inspection of seals of the bearings, cleaning the bearings of escaping grease, and filling and emptying storage containers with grease.

For carrying out the servicing work, it may be no longer necessary for a worker to leave the wind turbine generator system and carry out the servicing work from outside the rotor hub cladding. Consequently, the servicing work may be independent of effects caused by weathering and the safety risk for the worker carrying out the servicing work may be reduced significantly.

The hollow space between the rotor hub cladding and the rotor hub may be accessible for a worker from the end of the rotor hub that is opposite from the end intended for fastening to a nacelle of a wind turbine generator system.

The rotor hub of a wind turbine generator system may have an end that is intended for fastening to the nacelle of the wind turbine generator system. At the opposite end of the rotor hub, an opening in the casting of the rotor hub may allow access to the intermediate space between the rotor hub and the rotor hub cladding. From there it may be possible for a worker to reach the hollow space between the rotor hub cladding and the rotor hub, from which the servicing work on the fastening means and bearings of the rotor blades can be carried out.

An access in the end of the rotor hub that is opposite from the end intended for fastening the rotor hub to the nacelle of the wind turbine generator system means that the access to the hollow space between the rotor hub cladding and the rotor hub may be independent of the spatial position of the rotor hub after a rotation about the axis of rotation.

The opening in the rotor hub at this end of the rotor hub may not change its position during the rotation of the rotor hub. Consequently, the hollow space between the rotor hub cladding and the rotor hub may be accessible for the worker from inside the rotor hub without him having to leave the rotor hub cladding. The access to this hollow space may be always accessible in the same position.

The spacing between the rotor hub cladding and the rotor hub may become smaller with decreasing distance from a connecting point for receiving a rotor blade. This may have the effect that a sufficiently large hollow space is formed between the rotor hub cladding and the rotor hub to allow a worker to carry out the servicing work, while at the same time the rotor hub cladding comes closer to the rotor hub toward the periphery of the clearance intended for receiving a rotor blade.

This may give the rotor blade a more slender appearance. The space for the servicing work may be optimized without the aerodynamic properties of the rotor hub cladding having an adverse effect on the energy production of the wind turbine generator system. This form may lead to the forming of elevations between the clearances intended for receiving the rotor blades.

The rotor hub has an axis of rotation, and the rotor hub cladding may have a circular cross section around the axis of rotation at the end that is opposite from the end of the rotor hub intended for fastening to a nacelle of a wind turbine generator system.

The rotor hub of a wind turbine generator system has an axis of rotation. This axis of rotation may be identical to the later axis of rotation of the rotor hub in the operation of the wind turbine generator system. The rotor hub of the wind turbine generator system may have an end that is intended for fastening to the nacelle of a wind turbine generator system.

At the opposite end of the rotor hub, the rotor hub cladding may have a circular cross section around the axis of rotation. The rotor hub can consequently be closed by a rotationally symmetrical covering.

The cross section of the rotor hub cladding may be circular at the axial ends of the rotor hub cladding. The rotor hub may have an end that is intended for the later mounting on the nacelle of the wind turbine generator system and an end that is opposite from the first end.

The rotor hub cladding may have a circular cross section around the axis of rotation at both ends. This may allow a rotationally symmetrical seal or a rotationally symmetrical transition to the covering or to the nacelle to be provided at the ends.

This may also give the rotor hub cladding a more neutral form aerodynamically in rotation.

A continuous transition may be formed between the form of the rotor hub cladding at the axial ends of the rotor hub and the form of the surface of the rotor hub between the connecting points for receiving the rotor blades. Consequently, the elevations of the rotor hub cladding over the hollow space for servicing work may go over continuously into the circular cross section of the rotor hub cladding at the ends thereof.

Consequently, the form of the rotor hub cladding may be aerodynamically optimized and its influence on the energy production of the wind turbine generator system may be minimized.

The rotor hub may comprise three connecting points for receiving a rotor blade.

This may allow a form of construction of the wind turbine generator system with three rotor blades to be achieved. This form of construction of the wind turbine generator system may help ensure optimum utilization of the wind and a uniform expenditure of force in the rotation of the nacelle on the tower in the operation of the wind turbine generator system.

The rotor hub cladding may have clearances for three rotor blades. Consequently, the rotor hub cladding may be intended for a rotor hub for receiving three rotor blades.

### BRIEF DESCRIPTION

Some of the embodiments will be described in detail, with reference to the following figures, wherein like designations denote like members, wherein:

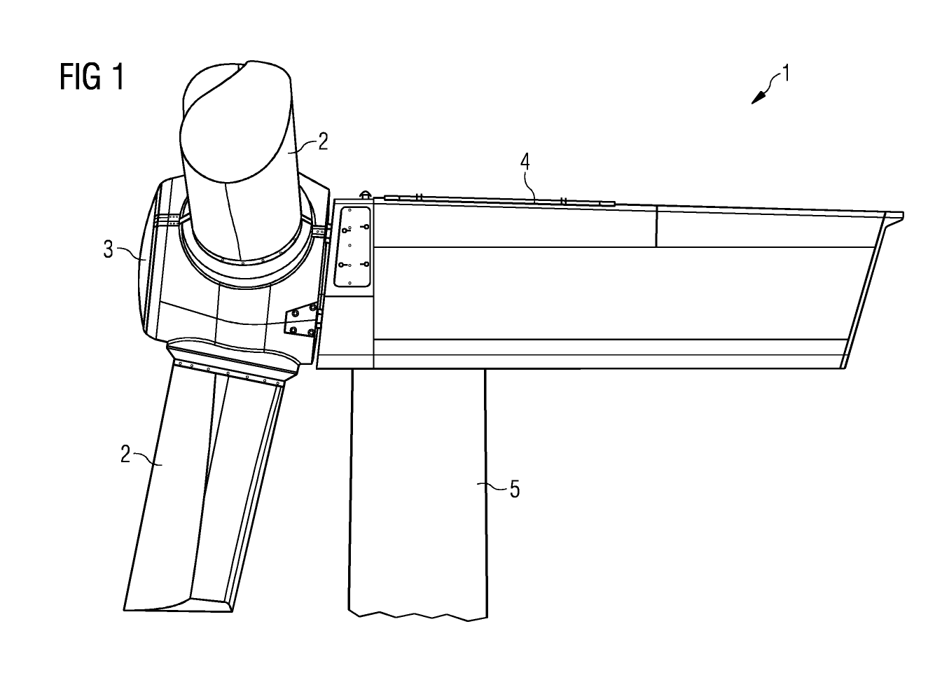

FIG. 1 shows a wind turbine generator system;

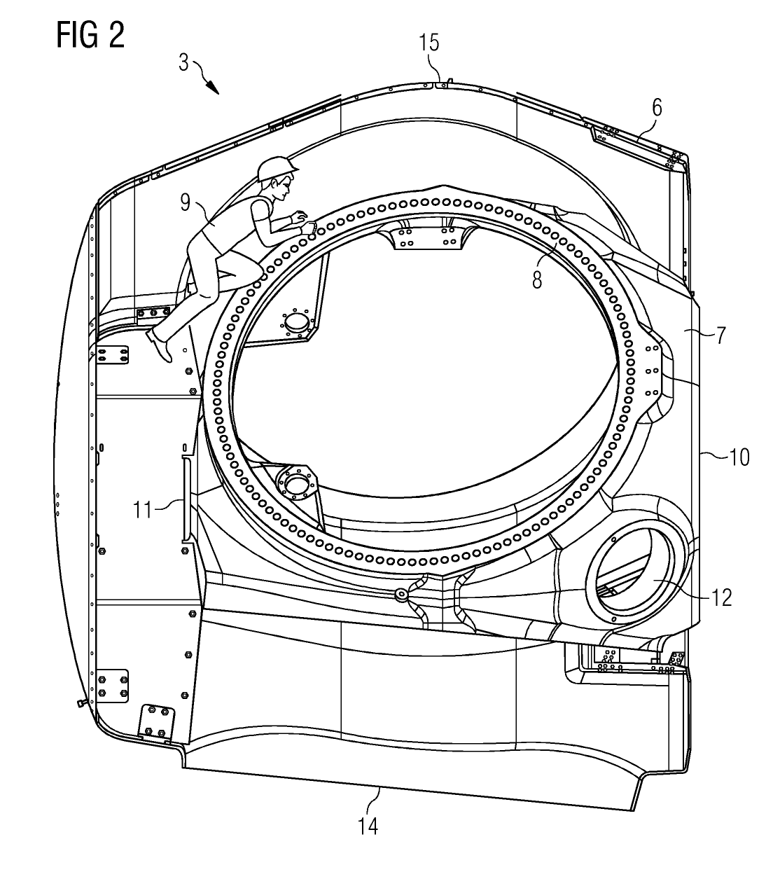

FIG. 2 shows the rotor hub of a wind turbine generator system;

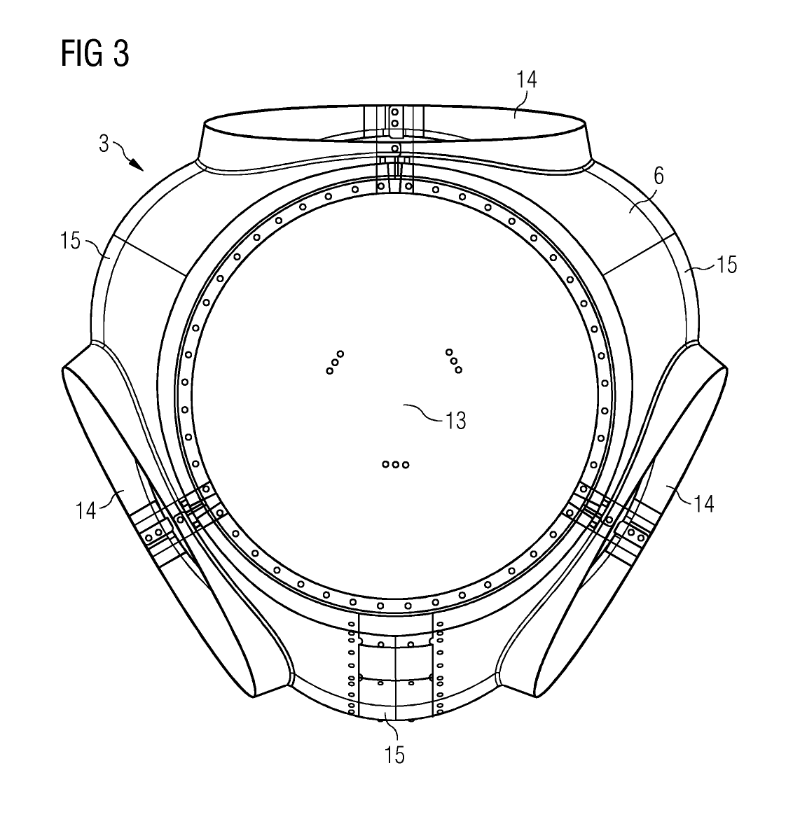

FIG. 3 shows a further view of the rotor hub;

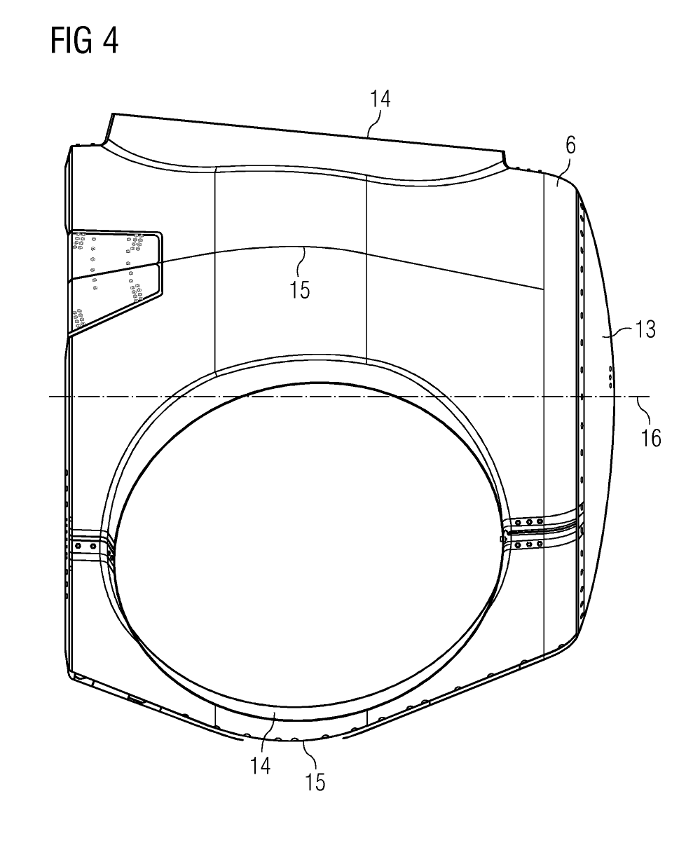

FIG. 4 shows a side view of the rotor hub cladding;

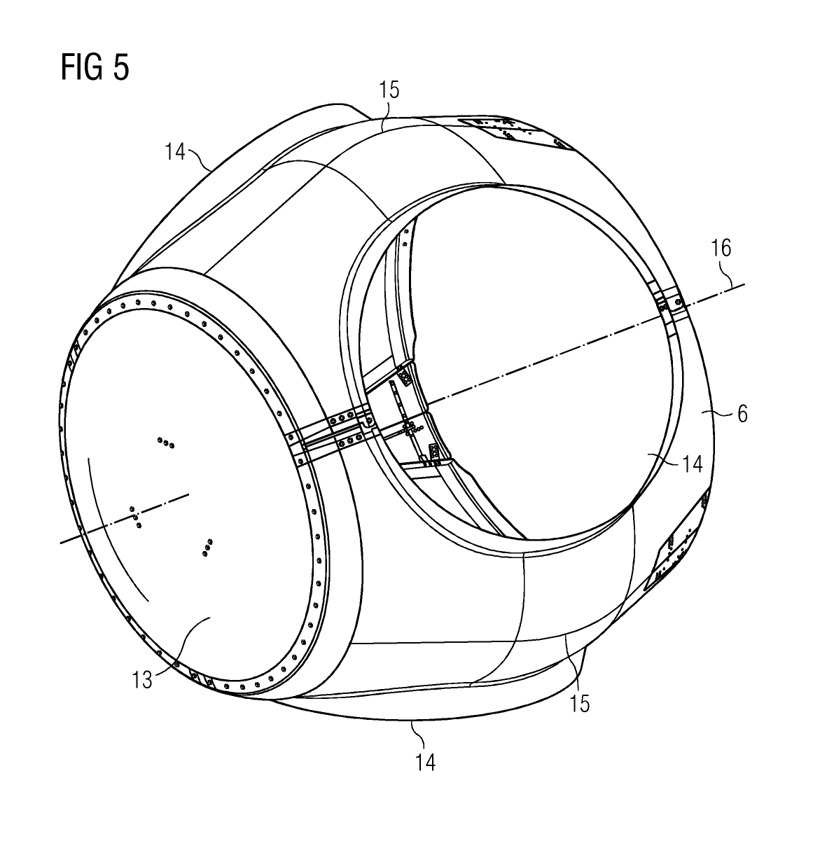

FIG. 5 shows a perspective view of the rotor hub cladding; and

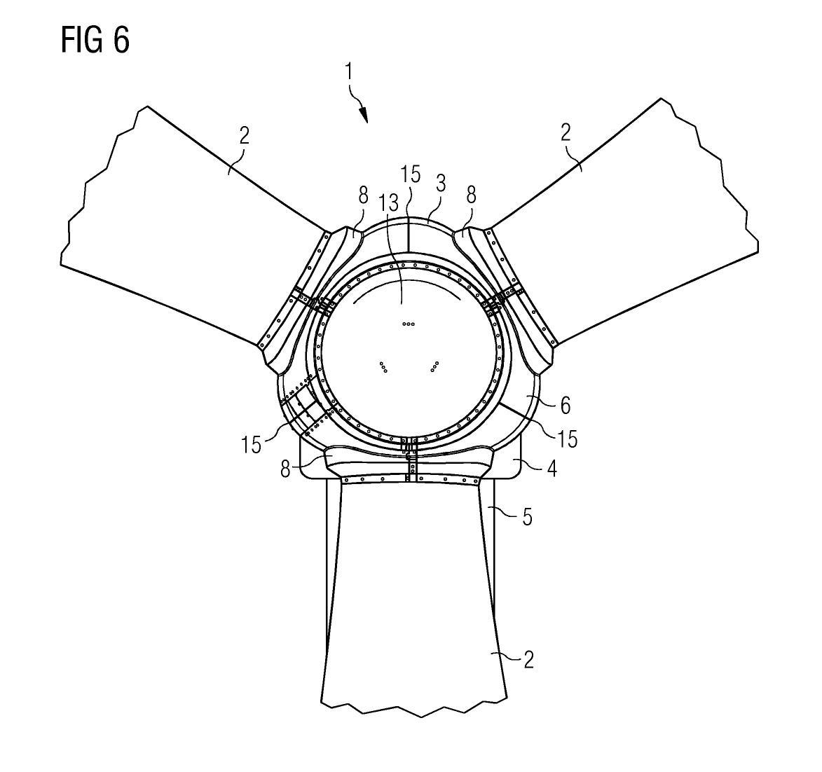

FIG. 6 shows a second view of the wind turbine generator system.

### DETAILED DESCRIPTION

FIG. 1 shows a wind turbine generator system.
FIG. 1 shows a wind turbine generator system 1. The wind turbine generator system 1 comprises a nacelle 4, which is rotatably arranged on a tower 5. A rotor hub 3 is rotatably attached to the nacelle 4. At least two rotor blades 2 are fastened to the rotor hub 3. In the operation of the wind turbine generator system 1, the wind acts on the rotor blades 2, which set the rotor hub 3 in rotation. The rotor blades 2 are attached to the rotor hub 3 in such a way that they are rotatable about its longitudinal axis.

FIG. 2 shows the rotor hub of a wind turbine generator system.
FIG. 2 shows the rotor hub 3 of a wind turbine generator system. The rotor hub 3 consists of a casting 7. The casting 7 has a flange 8, which is intended for receiving a rotor blade. The casting 7 of the rotor hub is surrounded by a rotor hub cladding 6.

The rotor hub 7 has at least two flanges 8 for receiving rotor blades. Between the two flanges 8 and the rotor hub 7, the spacing between the rotor hub and the rotor hub cladding 6 is formed such that servicing work on the connecting points of the rotor blades to the rotor hub 7 can be carried out by a worker 9 from the hollow space between the rotor hub 7 and the rotor hub cladding 6.

For this purpose, the rotor hub cladding 6 has an elevation 15 above the hollow space for servicing work. The hollow space for servicing work between the rotor hub 7 and the rotor hub cladding 6 is accessible for the worker 9 from the end 11 of the rotor hub 7.

The access to the hollow space for servicing work, in the spacing between the rotor hub 7 and the rotor hub cladding 6, may also be established by a manhole 12 in the rotor hub 7.

The rotor hub 7 has an end 10, at which the rotor hub 7 is intended for fastening to a nacelle of a wind turbine generator system. The end 10 of the rotor hub lies opposite from the end 11 of the rotor hub.

FIG. 3 shows a further view of the rotor hub.
FIG. 3 shows a further view of the rotor hub 3 toward the end 11 of the rotor hub. The rotor hub has a rotor hub cladding 6. The rotor hub cladding 6 shows three clearances 14 for receiving a rotor blade.

The rotor hub cladding 6 displays a round covering 13 over the end 11 of the rotor hub. In the region between the clearances for receiving the rotor blades 14, the rotor hub cladding 6 displays an elevation 15, which is located above the hollow space for servicing work.

FIG. 4 shows a side view of the rotor hub cladding.
FIG. 4 shows a side view of the rotor hub cladding 6. The rotor hub 7 and also the rotor hub cladding 6 have an axis of rotation 16, which corresponds to the axis of rotation of the rotor hub 7 in the later operation of the wind turbine generator system.

The rotor hub cladding 6 includes a covering 13 before the end 11 of the rotor hub 7. The rotor hub cladding 6 has clearances 14 for receiving the rotor blades. Over the hollow space for servicing work between the rotor hub cladding 6 and the rotor hub 7, the rotor hub cladding 6 forms elevations 15.

FIG. 5 shows a perspective view of the rotor hub cladding.
FIG. 5 shows a perspective view of the rotor hub cladding 6. The rotor hub cladding 6 displays a covering 13, which is located above the end 11 of the rotor hub 7. The rotor hub cladding 6 also has clearances 14, which serve for receiving rotor blades.

The elevations 15 are located above the hollow space for servicing work between the rotor hub 7 and the rotor hub cladding 6. The rotor hub cladding 6 has circular cross sections around the axis of rotation 16 at the ends 10 and 11 on the rotor hub 7.

FIG. 6 shows a second view of the wind turbine generator system.
FIG. 6 shows a second view of the wind turbine generator system 1. The view is directed here toward the end 11 or the covering 13 of the rotor hub 7. The rotor hub 3 displays a rotor hub cladding 6. The rotor hub is fastened to the nacelle 4 of the wind turbine generator system. The nacelle 4 is arranged on a tower 5. Three rotor blades 2 are fastened to the rotor hub 7.

The representation in the figures shows a schematic form of the invention. Similar or identical elements are provided with the same designations in the representations.

Even though the invention has been described in detail and with reference to a preferred embodiment, the invention is not restricted to the examples presented. Numerous additional variations and similar embodiments may be performed by a person skilled in the art without going beyond the range of the disclosure of the claims.

It is also noted that, within this text, “a” or “an” does not exclude the plural form, but that a/an may also denote a plurality. Furthermore, the use of “comprise” does not rule out that further elements, contents or steps that are not mentioned may be included in the device or in the method.

Elements that have been described in connection with various embodiments may also occur in combination. The designations in the claims serve for illustrating the invention and do not restrict the content of the claims.

1. A rotor hub of a wind turbine generator system,
the rotor hub comprising at least two connecting points for respectively receiving a rotor blade,
the rotor hub being surrounded by a cladding,
the cladding having at least two clearances respectively for a rotor blade,
characterized in that
between the two connecting points for receiving the rotor blades, the spacing between the rotor hub cladding and the rotor hub is set so as to create between the rotor hub cladding and the rotor hub a hollow space that is large enough to allow servicing work on the connecting point between the rotor blade) and the rotor hub to be carried out by a worker from there.

2. The rotor hub of a wind turbine generator system as claimed in claim 1, characterized in that the rotor blades are attached to the rotor hub by means of fastening means, and in that the fastening means are accessible from the hollow space between the rotor hub and the rotor hub cladding.

3. The rotor hub of a wind turbine generator system as claimed in claim 1, characterized in that the rotor blades are connected to the rotor hub by way of bearings, and in that the bearings are accessible from the hollow space between the rotor hub and the rotor hub cladding.

4. The rotor hub of a wind turbine generator system as claimed in claim 1, characterized in that the hollow space between the rotor hub cladding and the rotor hub is accessible for a worker from the end of the rotor hub) that is opposite from the end intended for fastening to a nacelle of a wind turbine generator system.

5. The rotor hub of a wind turbine generator system as claimed in claim 1, characterized in that the spacing between the rotor hub cladding and the rotor hub becomes smaller with decreasing distance from a connecting point for receiving a rotor blade.

6. The rotor hub of a wind turbine generator system as claimed in claim 1, characterized in that the rotor hub has an axis of rotation, and in that the rotor hub cladding has a circular cross section around the axis of rotation at the end that is opposite from the end of the rotor hub intended for fastening to a nacelle of a wind turbine generator system.

7. The rotor hub of a wind turbine generator system as claimed in claim 1, characterized in that the cross section of the rotor hub cladding is circular at the axial ends of the rotor hub cladding.

8. The rotor hub of a wind turbine generator system as claimed in claim 6, characterized in that a continuous transition is formed between the form of the rotor hub cladding at the axial ends of the rotor hub and the form of the surface of the rotor hub between the connecting points for receiving the rotor blades.

9. The rotor hub of a wind turbine generator system as claimed in claim 1, characterized in that the rotor hub comprises three connecting points for receiving a rotor blade.

10. The rotor hub of a wind turbine generator system as claimed in claim 9, characterized in that the rotor hub cladding has clearances for three rotor blades.
